(19) United States
(12) Patent Application Publication
(10) Pub. No.: US 2013/0266880 A1
(43) Pub. Date: Oct. 10, 2013

(54) METHOD AND ARRANGEMENT FOR AVOIDING ANODE OXIDATION

(71) Applicant: CONVION OY, (US)

(72) Inventors: Kim ASTRÖM, Kirkkonummi (FI); Tuomas HAKALA, Helsinki (FI); Tero HOTTINEN, Lohja (FI)

(73) Assignee: CONVION OY, Espoo (FI)

(21) Appl. No.: 13/836,578

(22) Filed: Mar. 15, 2013

Related U.S. Application Data
(63) Continuation of application No. PCT/FI2011/050620, filed on Jun. 30, 2011.

(30) Foreign Application Priority Data
Sep. 17, 2010 (FI) 20105962

(51) Int. Cl. H01M 8/04

(52) U.S. Cl. CPC H01M 8/04664
USPC 429/429

(57) ABSTRACT

An exemplary cooling arrangement for high temperature fuel cell system for substantially reducing the amount of purge gas in a system shutdown situation includes a fuel cell having an anode side, a cathode side, and an electrolyte between the anode side and the cathode side. The cooling arrangement includes a coolant source capable of providing coolant to be used in a cooling process of the high temperature fuel cell system during the system shutdown situation, and a cooling structure in connection with the coolant source arranged in a thermal effect area of the fuel cell stacks. The arrangement also includes the vessel that feeds the coolant into the cooling structure from the coolant source, a heat exchanger that exhausts used coolant from the cooling structure, and an actuating device that uses a triggering force to trigger a coolant flow in the cooling structure, when the system shutdown situation has started.

RELATED APPLICATION(S)

This application is a continuation under 35 U.S.C. §120 of International Application PCT/FI2011/050620 filed on Jun.30, 2011, designating the U.S., and claiming priority to Finnish application 2010 5962 filed in Finland on Sep. 17, 2010. The content of each priority document is incorporated by reference in its entirety.

### FIELD

This disclosure relates to a fuel cell, and particularly to a method and arrangement of avoiding anode oxidation.

### BACKGROUND INFORMATION

Most of the energy of the world is produced by means of oil, coal, natural gas or nuclear power. All these production methods have their specific problems as far as, for example, availability and friendliness to environment are concerned. As far as the environment is concerned, oil and coal cause pollution when they are combusted. The problem with nuclear power is, at least, storage of used fuel. Because of the environmental problems, new energy sources, more environmentally friendly and, for example, having a better efficiency than the above-mentioned energy sources, have been developed. In known fuel cells, by means of which energy of fuel, for example biogas, is directly convert to electricity via a chemical reaction in an environmentally friendly process, are promising future energy conversion devices.

FIG. 1 illustrates a single fuel cell structure according to a known implementation. As shown in FIG. 1, the fuel cell, includes an anode side 100 and a cathode side 102 and an electrolyte material 104 between them. In solid oxide fuel cells (SOFCs) oxygen 106 is fed to the cathode side 102 and it is reduced to a negative oxygen ion by receiving electrons from the cathode. The negative oxygen ion goes through the electrolyte material 104 to the anode side 100 where it reacts with fuel 108 producing water and under some conditions carbon dioxide (CO2). Between anode 100 and cathode 102 is an external electric circuit 111 including a load 110 for the fuel cell.

FIG. 2 illustrates an example of a SOFC device according to a known implementation. As shown in FIG. 2, a SOFC device as an example of a high temperature fuel cell device. SOFC device can utilize as fuel for example natural gas, bio gas, methanol or other compounds containing hydrocarbons. The SOFC device in FIG. 2 includes more than one, and in some implementations plural of fuel cells in stack formation 103 (SOFC stack). Each fuel cell includes anode 100 and cathode 102 structure as presented in FIG. 1. Part of the used fuel can be recirculated in feedback arrangement 109 through each anode. The SOFC device in FIG. 2 also includes fuel heat exchanger 105 and reformer 107. Several heat exchangers are used for controlling thermal conditions at different locations in a fuel cell process. Reformer 107 is a device that converts the fuel such as for example natural gas to a composition suitable for fuel cells, for example to a composition containing hydrogen and methane, carbon dioxide, carbon monoxide and inert gases. Anyway in each SOFC device it is though not necessary to have a reformer.

For example inert gases are purge gases or part of purge gas compounds used in fuel cell technology. For example nitrogen is an inert gas used as purge gas in fuel cell technology. Purge gases are not necessarily elemental and they can be also compound gases.

By using measurement means 115 (such as fuel flow meter, current meter and temperature meter), measurements can be carried out for the operation of the SOFC device. Part of the gas used at anodes 100 can be recirculated through anodes in feedback arrangement 109 and the other part of the gas is exhausted 114 from the anodes 100.

A solid oxide fuel cell (SOFC) device is an electrochemical conversion device that produces electricity directly from oxidizing fuel. Advantages of SOFC device include high efficiencies, long term stability, low emissions, and cost. The main disadvantage is the high operating temperature which results in long start up times and both mechanical and chemical compatibility issues.

The anode electrode of solid oxide fuel cell (SOFC) can contain significant amounts of nickel that is vulnerable to forming nickel oxide if the atmosphere is not reducing. If nickel oxide formation is severe, the morphology of electrode can be changed irreversibly causing significant loss of electrochemical activity or even break down of cells. Hence, SOFC systems can call for purge gas, e.g., safety gas, containing reductive agents (such as hydrogen diluted with inert such as nitrogen) during the start-up and shut-down in order to prevent the fuel cell's anode electrodes from oxidation. In known systems the amount of purge gas has to be minimized because an extensive amount of, e.g. pressurized gas containing hydrogen, are expensive and problematic as space-requiring components.

According to known implementations the amount of purge gases during normal start-up or shut-down can be minimized by anode recirculation, e.g., circulating the non-used purge gases back to the loop, as there can be specification for minimization of the purge gases and heating in the start-up situation and also a specification for minimization of the purge gases and cooling of the system in the shut-down situation. However, in emergency shut-down (ESD) that can be caused e.g. by gas alarm or black-out, and active recirculation can be unavailable, thereby increasing the amount of specified purge gas. In addition, the cathode air flow is not cooling the system during the ESD, because the air blower has to be shut down, and hence the amount of specified purge gas is even more increased as the time to cool the system down to temperatures where nickel oxidation does not happen is even three-fold compared to active shut-down situation.

As described, current SOFC stacks specify reducing purge gas to protect the anode from oxidation during abnormal situations, like emergency shutdowns. However, still the amount of purge gas is considerable for real field application, such as with larger unit sizes. Stacks are vulnerable towards detrimental nickel oxidation above a certain critical temperature, which can range somewhere between 300-400 degrees Celsius. Below this temperature, nickel oxidation reaction is so slow that the specification no longer calls for a reductive atmosphere on the anode. In passive emergency shutdown (ESD) situations, the cooling of the unit is extremely slow (even up to 10 hours or more) due to non-existing air flow through the system, high heat capacitance of the components, and good thermal insulation of the system. Even if active air cooling could be utilized, the cooling is slow because of high efficiency recuperator bringing most of the heat back to the system.

For example in patent application document JP 2009 170307 A is concentrated on active operation exemplary embodiment, e.g., on active controlling of the fuel system by using a pump, etc. A person skilled in the art well knows that such active exemplary embodiments suffer from defective operability, for example, in the emergency shutdown situations.

### SUMMARY

An exemplary high temperature fuel cell system is disclosed comprising: a cooling arrangement for substantially reducing an amount of purge gas in a system emergency shutdown situation, wherein each fuel cell in the fuel cell system having an anode side, a cathode side, and an electrolyte between the anode side and the cathode side, the fuel cells being arranged in fuel cell stacks; the cooling arrangement including: a coolant source that provides coolant to be used in a cooling process of the high temperature fuel cell system during the system shutdown situation, a cooling structure connected to the coolant source and arranged in a thermal effect area of the fuel cell stacks to receive heat from the fuel cell stacks at least by radiation, and transferring received heat to the coolant; means for feeding said coolant into the cooling structure from the coolant source; means for exhausting used coolant from the cooling structure; means for utilizing a triggering force to trigger a coolant flow in the cooling structure, when the system shutdown situation has started; wherein the means for feeding includes feeding a separate tank arrangement configured to use pressurized gas as a driving force for feeding the coolant into the cooling structure, and means for dimensioning the flow rate of coolant according to a cooling duty and allowed cooling rate of the fuel cell stacks using a triggering force to perform passive self-actuation type operation.

An exemplary method for substantially reducing the amount of purge gas in a system emergency shutdown situation in a high temperature fuel cell system is disclosed, in which fuel cells have been arranged in fuel cell stacks, comprising: feeding coolant to a cooling structure during the system emergency shutdown situation, the cooling structure being arranged in a thermal effect area of the fuel cell stacks, receiving at the cooling structure heat from the fuel cell stacks at least by radiation and transferring the received heat to the coolant; triggering the coolant flow, which is fed into the cooling structure, into the cooling structure, when the system shutdown situation has started; and exhausting coolant from the cooling structure; wherein feeding the coolant is performed from a separate tank arrangement using pressurized gas as a driving force for feeding the coolant into the cooling structure, and a flow rate of coolant is dimensioned according to a cooling duty and allowed cooling rate of the fuel cell stacks by using passive self-actuation type operation accomplished by said triggering.

An exemplary high temperature fuel cell system is disclosed comprising: a cooling arrangement that reduces an amount of purge gas in a system emergency shutdown situation, wherein each fuel cell in the fuel cell system having an anode side, a cathode side, and an electrolyte between the anode side and the cathode side, the fuel cells being arranged in fuel cell stacks; the cooling arrangement including: a coolant source that provides coolant to be used in a cooling process of the high temperature fuel cell system during the system shutdown situation, a cooling structure connected to the coolant source and arranged in a thermal effect area of the fuel cell stacks to receive heat from the fuel cell stacks at least by radiation, and transferring received heat to the coolant; a membrane expression vessel that feeds said coolant into the cooling structure from the coolant source; a heat exchanger that exhausts used coolant from the cooling structure; an actuated device that utilizes a triggering force to trigger a coolant flow in the cooling structure, when the system shutdown situation has started; wherein the membrane expression vessel includes feeding a separate tank arrangement configured to use pressurized gas as a driving force to feed the coolant into the cooling structure, and the actuated device dimensioning the flow rate of coolant according to a cooling duty and allowed cooling rate of the fuel cell stacks using a triggering force to perform passive self-actuation type operation.

### BRIEF DESCRIPTION OF THE DRAWINGS

Exemplary embodiments of the disclosure are explained in more detail below on the basis of the accompanying drawing, in which:

FIG. 1 illustrates a single fuel cell structure according to a known implementation;

FIG. 2 illustrates an example of a SOFC device according to a known implementation;

FIG. 3 illustrates a cooling arrangement for high temperature fuel cell system according to an exemplary embodiment of the present disclosure; and

FIG. 4 illustrates a cooling arrangement with a coolant feed for a high temperature fuel cell system according to an exemplary embodiment of the present disclosure.

### DETAILED DESCRIPTION

Exemplary embodiments of the present disclosure provide a fuel cell system where the risk of anode oxidation in shut-down situations is significantly reduced. This is achieved by a high temperature fuel cell system including a cooling arrangement for substantially reducing the amount of purge gas in a system emergency shutdown situation or similar, each fuel cell in the fuel cell system including an anode side, a cathode side, and an electrolyte between the anode side and the cathode side, the fuel cell system including the fuel cells in fuel cell stacks, and the cooling arrangement includes a coolant source capable of providing coolant to be used in a cooling process of the high temperature fuel cell system during the system shutdown situation, a cooling structure in connection to the coolant source and arranged in a thermal effect area of the fuel cell stacks for receiving heat from the fuel cell stacks at least by radiation and transferring received heat to the coolant, means for feeding said coolant into the cooling structure from the coolant source, means for exhausting used coolant from the cooling structure, and means for utilizing a triggering force to trigger a coolant flow in the cooling structure, when the system shutdown situation has started. The cooling arrangement includes as the means a separate tank arrangement to utilize pressurized gas as a driving force for feeding the coolant to the cooling structure, and means for dimensioning the flow rate of coolant according to the specified cooling duty and allowed cooling rate of the fuel cell stacks by utilizing a triggering force to perform passive self-actuation type operation.

Exemplary embodiments of the disclosure provide a method for substantially reducing the amount of purge gas in a system emergency shutdown situation or similar in a high temperature fuel cell system, in which fuel cells have been arranged in fuel cell stacks, and in the method a coolant is utilized in a cooling process of the high temperature fuel cell system during the system shutdown situation by feeding said coolant to a cooling structure, which has been arranged in a thermal effect area of the fuel cell stacks for receiving heat from the fuel cell stacks at least by radiation and transferring received heat to the coolant, and the coolant flow, which is fed into the cooling structure, is triggered into the cooling structure, when the system shutdown situation has started, and used coolant is exhausted from the cooling structure. The feeding of the coolant is performed from a separate tank arrangement by utilizing pressurized gas as a driving force for feeding the coolant to the cooling structure, and the flow rate of coolant has been dimensioned according to the specified cooling duty and allowed cooling rate of the fuel cell stacks by utilizing passive self-actuation type operation accomplished by said triggering.

Exemplary embodiments disclosed herein are based on the utilization of coolant, which can have high heat capacity characteristics, and the flowing arrangement of said coolant (e.g., substantially) nearby the hot fuel cell stacks. By this way enhancing the cooling rate of the high temperature fuel cell systems, for example during ESD (Emergency Shut-Down) situations, the amount of specified purge gas can be significantly reduced in cooling processes of the high temperature fuel cell systems.

Exemplary embodiments of the disclosure provide a benefit in that the risk of anode oxidation in system shut down situations can be significantly reduced and lifetime of the fuel cell system can be increased in a cost effective manner. Also a substantial amount of energy production time can be spared because of the faster cooling process.

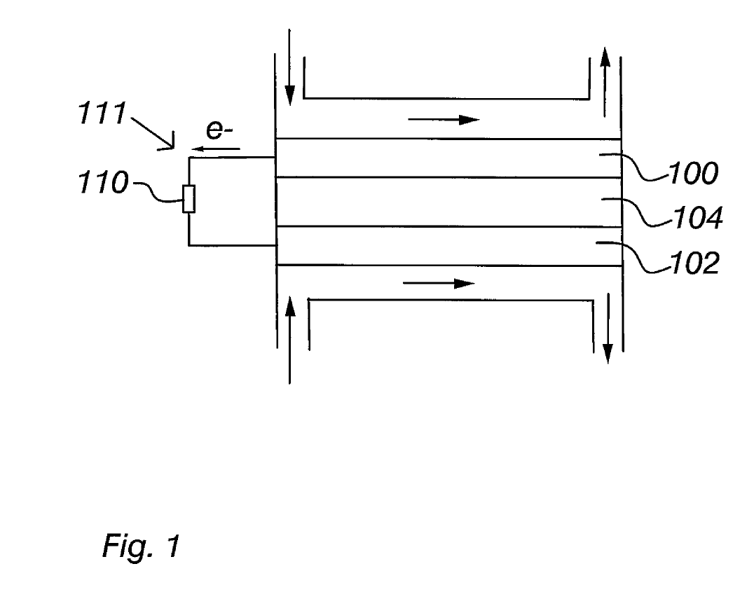

Solid oxide fuel cells (SOFCs) can have multiple geometries. FIG. 1 shows an SOFC with a planar geometry, (FIG. 1) is a sandwich type geometry employed by a number of known types of fuel cells, where the electrolyte 104 is sandwiched in between the electrodes, anode 100 and cathode 102. SOFCs can also be made in tubular geometries where for example either air or fuel is passed through the inside of the tube and the other gas is passed along the outside of the tube. This can be also arranged so that the gas used as fuel is passed through the inside of the tube and air is passed along the outside of the tube. Other geometries of SOFCs include modified planar cells (MPC or MPSOFC), where a wave-like structure replaces the traditional flat configuration of the planar cell. Such designs are promising, because they share the advantages of both planar cells (low resistance) and tubular cells.

The ceramics used in SOFCs do not become ionically active until they reach a very high temperature and as a consequence of this the stacks have to be heated at temperatures ranging from 600 to 1,000° C. Reduction of oxygen 106 (FIG. 1) into oxygen ions occurs at the cathode 102. These ions can then be transferred through the solid oxide electrolyte 104 to the anode 100 where they can electrochemically oxidize the gas used as fuel 108. In this reaction, water and carbon dioxide byproducts are given off as well as two electrons. These electrons then flow through an external circuit 111 where they can be utilized. The cycle then repeats as those electrons enter the cathode material 102 again.

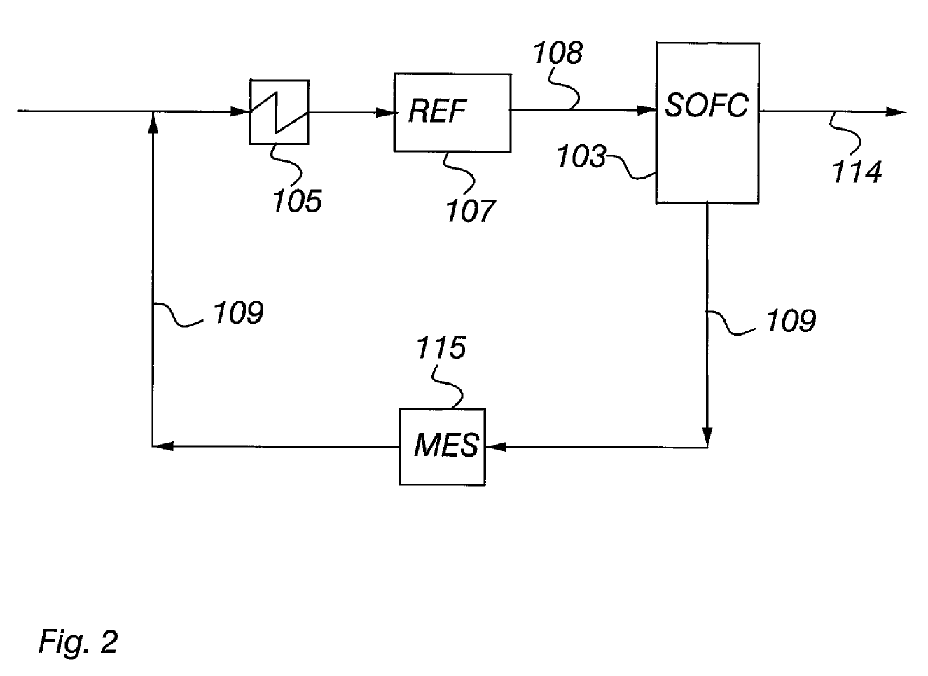

In large solid oxide fuel cell systems fuels can be natural gas (mainly methane), different biogases (mainly nitrogen and/or carbon dioxide diluted methane), and other higher hydrocarbon containing fuels, including alcohols. Methane and higher hydrocarbons should be reformed either in the reformer 107 (FIG. 2) before entering the fuel cell stacks 103 or (partially) internally within the stacks 103. The reforming reactions can call for a certain amount of water, and additional water can be used to prevent possible carbon formation (coking) caused by higher hydrocarbons. This water can be provided internally by circulating the anode gas exhaust flow, because water is produced in excess amounts in fuel cell reactions, and/or said water can be provided with an auxiliary water feed (e.g. direct fresh water feed or circulation of exhaust condensate). By anode recirculation arrangement also part of the unused fuel and dilutants in anode gas are fed back to the process, whereas in auxiliary water feed arrangement only additive to the process is water. Because anode electrode of a solid oxide fuel cell can consist of a porous, nickel matrix ceramic-metallic structure which morphology can be relied upon for cell performance, oxidation of nickel can change the fuel cells performance irreversibly. This is why SOFC systems specify use of purge gas containing reductive agents, such as hydrogen diluted with inert such as nitrogen, in order to prevent anode electrodes of the fuel cell system from oxidation. In practical fuel cell systems it is uneconomical to maintain an excessive purge gas storage, e.g., the amount of safety gas should be minimized. Also a pressurization arrangement, which can be specified for the use of purge gas, has a significant effect on the physical size of the fuel cell system.

To minimize the use of purge gas in exemplary embodiments according to the present disclosure heat is rapidly absorbed from the stacks 103 and surroundings by utilizing passive heat is absorption means. By this way, the temperature level of the stacks can be brought to a level where purge gases are no longer relied upon, or, at least not in significant quantities. This can be achieved, e.g., by feeding water, or some other medium that has high heat capacity and/or high latent heat of phase change, into the hot compartment of the system after ESD, and hence absorbing the heat by heating and evaporating the water. The water could, e.g., be fed into a dedicated structure where it is let to flow through a pre-fixed restriction from a tank above the hot compartment by utilizing gravitation force. A simple cooling structure can be arranged for example by a pipe structure directed to flow coolant from the tank above the hot fuel cell stack compartments down beside the hot compartments, and the same pipe structure can also exhaust below the fuel cell stack compartments used coolant by utilizing gravitation force. The effective steam generation in the pipe structure beside the hot compartments prevents speed of flowing coolant to a certain speed level.

The high temperature of the hot fuel cell stack compartments heat and evaporate the water, for example at higher temperatures in the beginning of the cooling process, by radiative heat transfer, and hence the removal of heat from the hot structures is effective. The water flow rate could be restricted in a way that the cooling does not cause too high thermal gradients within the system. In the structure where the water is fed, there could be a pressure relief valve (or similar setup) to prevent hazardous pressure accumulation of the evaporated water. The bleeding from relief valve could be directed safely into e.g. exhaust pipe of the system, which could be drained after ESD as there will be condensed water after cooling.

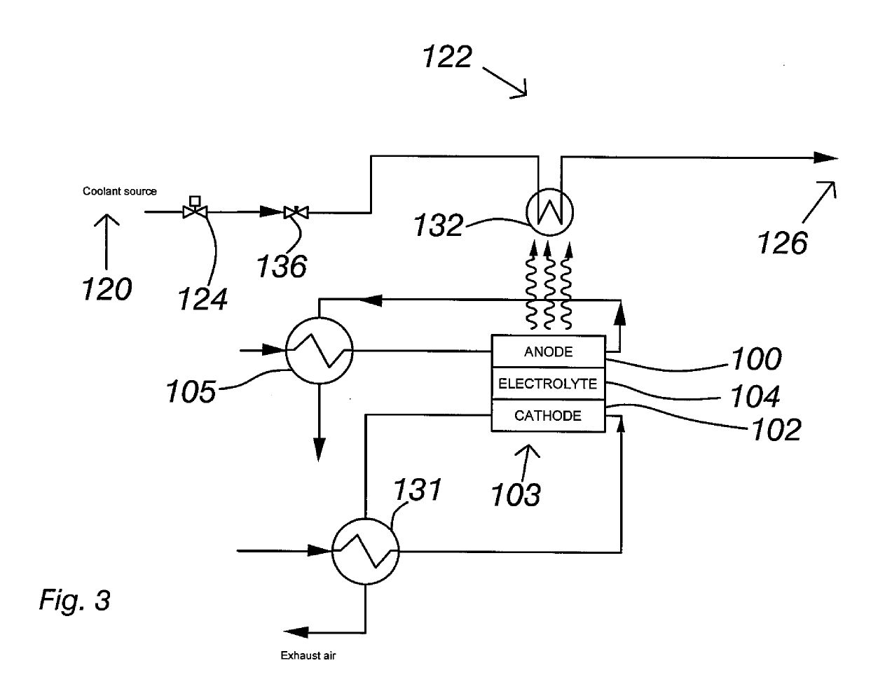

FIG. 3 illustrates a cooling arrangement for high temperature fuel cell system according to an exemplary embodiment of the present disclosure. As shown in FIG. 3, the cooling arrangement includes, a coolant source 120 capable of providing coolant to be used in a cooling process of the high temperature fuel cell system during a system shutdown situation. Water or some other liquid suitable for cooling purposes is used as a coolant, and the source 120 is for example a water inlet from water pipe network or a tank arrangement containing water (or other coolant) or whichever source providing coolant to the cooling arrangement. A cooling structure 122 is in connection to the coolant source 120 and has been arranged in a thermal effect area of the fuel cell stacks 103 for receiving heat from the fuel cell stacks at least by radiation and transferring received heat to the coolant. Along said connection between the coolant source 120 and the cooling structure 122 are means 124 for feeding said coolant into the cooling structure 122 from the coolant source 120. Said means 124, can be accomplished for example by a valve arrangement. The cooling arrangement also include means 126 for exhausting used coolant from the cooling structure 122. The most simplified example of means 126 are for example just a pipe, which exhausts the flow of used coolant from the cooling structure 122.

When the system shutdown situation of the fuel cell system starts, the cooling arrangement shut-down triggers flow of coolant to the cooling structure by means 136 at a flow rate limited by said means 136 for utilizing a triggering force to trigger a coolant flow in the cooling structure 122. Means 136 are accomplished for example by utilizing a spring valve or a pressurization arrangement to perform for example passive self-actuation type operation in said triggering. The operation of the cooling structure 122 can be integrated with the operation of the fuel heat exchanger 105 in the anode sides of the stacks 103. In FIG. 3 is also presented a possibility that some gas, for example nitrogen, flows in the cathode sides 102 in the shutdown situation, and thus FIG. 3 also presents an gas heat exchanger 131 and exhaust outlet of gas used in cooling process in the cathode sides 102 of the stacks 103.

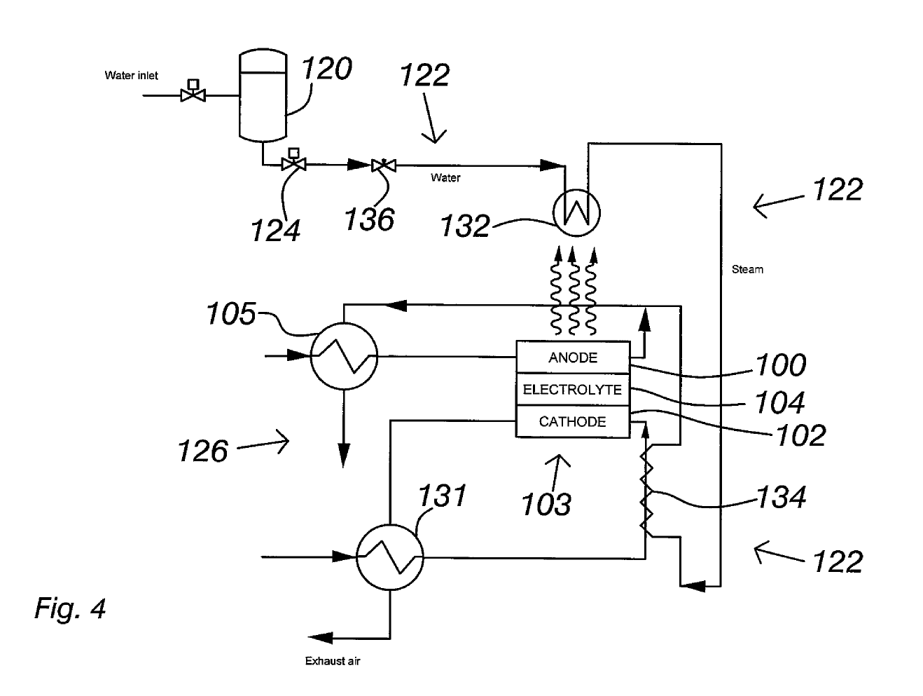

FIG. 4 illustrates a cooling arrangement with a coolant feed for a high temperature fuel cell system according to an exemplary embodiment of the present disclosure. FIG. 4 shows an exemplary structure for substantially reducing the amount of purge gas in a system shut down situation of high temperature fuel cell system. A cooling arrangement includes a coolant source 120, which can contain water as coolant. In an exemplary embodiment the coolant source can be located above fuel cell stacks 103, and gravitation force is utilized by a restriction function part 136 to let a restricted flow of coolant in accordance with a predetermined coolant flow rate to flow down in a cooling structure 122 essentially (e.g., substantially) near the fuel cell stacks by utilizing gravitation force. Thus the restriction function part is also one example of said means 136 for utilizing a triggering force. In most cases the system shutdown situation is an ESD (Emergency Shut-Down) situation. The cooling structure 122 is in connection to the coolant source 120 and arranged essentially (e.g., substantially) in a thermal effect area of the fuel cell stacks 103 for receiving heat from the fuel cell stacks at least by radiation and transferring received heat to the coolant, e.g., water, inside the cooling structure 122. In said transferring of heat from the stacks to water, e.g., in fuel cell stacks cooling process, is utilized phase transition of water to steam.

The exemplary cooling arrangement of FIG. 4 further includes means 124 for feeding said coolant from the coolant source 120 into the cooling structure 122. There are several alternatives for said means 124. For example means 124 can be arranged by using a separate tank arrangement 124. In the operation of said separate tank arrangement 124 can be utilized a pressurization arrangement to feed water from the coolant source 120 into the cooling structure 122. Said means 124 can also be for example a membrane expansion vessel 124, which utilizes pressurized gas in performing pressurized action to feed coolant from the vessel 124 into the cooling structure 122.

When the ESD (Emergency Shut-Down) situation has started, the coolant flow, which is fed into the cooling structure 122 by the means 124, is also triggered at a predetermined rate to the cooling structure by means 136 for utilizing a triggering force. Means 136 can be capable of performing passive self-actuation type operation. Said means 136 for utilizing a triggering force to trigger a coolant flow in the cooling structure can also be so arranged that passive operation accomplished by said triggering is performed by utilizing a pressure reserve existing in the cooling arrangement. Said means 136 can also be capable of dimensioning the flow rate of coolant according to the specified cooling duty and allowed cooling rate of the fuel cell stacks 103 so that the coolant flow is triggered at a predetermined flow rate to the cooling structure 122 by the means 136.

In an exemplary embodiment of the present disclosure heat radiation absorption efficiency of the cooling structure 122 is enhanced by using platy structure parts in the cooling structure for the coolant to maximise heat radiation absorption area of the cooling structure. These platy structure parts can be arranged for example to a heat radiation exchanger 132, which is a cooling unit in the cooling structure 122 specialized to absorb, such as heat radiation from the fuel cell stacks 103 and to transfer absorbed heat to coolant, e.g., water flowing in the cooling structure 122.

Furthermore to grow cooling efficiency of the cooling arrangement, the cooling structure 122 includes a sheath structure 134 to absorb heat from the fuel cell stacks 103 for cooling at least one of the anode side 100 and cathode side 102 of the fuel cell system. The absorbed heat is further transferred through the sheath structure 134 to the coolant. FIG. 4 shows an exemplary structure in which the sheath structure 134 is located only in the cathode sides 100 of the fuel cell stacks 103, but as said, the sheath structure can also be utilized in the cooling of the fuel cell stacks 103 in the anode sides 102 of the stacks 103. The operation of the cooling structure 122 can be integrated with the operation of the fuel heat exchanger 105 in the anode sides of the stacks 103.

According to an exemplary cooling arrangement as shown in FIG. 4 can also include means 126 for injecting used coolant to reactant exhaust piping to utilize used coolant in operation of other parts of the fuel cell system. In the cooling structure 122 and in relevant parts, such as the sheath structure 134 and the heat radiation exchanger 132 suitable metal material or some other material can be used which tolerates very high temperatures for even up to 1000 degrees of and Celsius and more.

Thus, it will be appreciated by those skilled in the art that the present disclosure can be embodied in other specific forms without departing from the spirit or essential characteristics thereof. The presently disclosed exemplary embodiments are therefore considered in all respects to be illustrative and not restricted. The scope of the disclosure is indicated by the appended claims rather than the foregoing description and all changes that come within the meaning and range and equivalence thereof are intended to be embraced therein.

What is claimed is:

1. A high temperature fuel cell system comprising :
a cooling arrangement for substantially reducing an amount of purge gas in a system emergency shutdown situation, wherein each fuel cell in the fuel cell system having an anode side, a cathode side, and an electrolyte between the anode side and the cathode side, the fuel cells being arranged in fuel cell stacks;
the cooling arrangement including:
a coolant source that provides coolant to be used in a cooling process of the high temperature fuel cell system during the system shutdown situation,
a cooling structure connected to the coolant source and arranged in a thermal effect area of the fuel cell stacks to receive heat from the fuel cell stacks at least by radiation, and transferring received heat to the coolant;
means for feeding said coolant into the cooling structure from the coolant source;
means for exhausting used coolant from the cooling structure;
means for utilizing a triggering force to trigger a coolant flow in the cooling structure, when the system shutdown situation has started;
wherein the means for feeding includes feeding a separate tank arrangement configured to use pressurized gas as a driving force for feeding the coolant into the cooling structure, and means for dimensioning the flow rate of coolant according to a cooling duty and allowed cooling rate of the fuel cell stacks using a triggering force to perform passive self-actuation type operation.

2. The high temperature fuel cell system in accordance with claim 1, wherein the cooling arrangement includes water as said coolant to receive heat from the fuel cell system, and using a phase transition of water to steam in the cooling process.

3. The high temperature fuel cell system in accordance with claim 1, wherein the cooling structure includes platy structure parts for the coolant to enhance heat radiation absorption efficiency of the cooling structure.

4. The high temperature fuel cell system in accordance with claim 1, wherein the cooling structure includes a sheath structure to absorb heat from the fuel cell stacks by using said coolant for cooling at least one of the anode side and cathode side of the fuel cell system.

5. A method for substantially reducing the amount of purge gas in a system emergency shutdown situation-in a high temperature fuel cell system, in which fuel cells have been arranged in fuel cell stacks, comprising:
feeding coolant to a cooling structure during the system emergency shutdown situation, the cooling structure being arranged in a thermal effect area of the fuel cell stacks,
receiving at the cooling structure heat from the fuel cell stacks at least by radiation and transferring the received heat to the coolant;
triggering the coolant flow, which is fed into the cooling structure, into the cooling structure, when the system shutdown situation has started; and
exhausting coolant from the cooling structure;
wherein feeding the coolant is performed from a separate tank arrangement using pressurized gas as a driving force for feeding the coolant into the cooling structure, and a flow rate of coolant is dimensioned according to a cooling duty and allowed cooling rate of the fuel cell stacks by using passive self-actuation type operation accomplished by said triggering.

6. The method in accordance with claim 5, wherein, water is used as said coolant to receive heat from the fuel cell system, and a phase transition of the water to steam is used in the cooling process.

7. The method in accordance with claim 5, wherein a heat radiation absorption efficiency of the cooling structure is enhanced by using platy structure parts in the cooling structure for the coolant.

8. The method in accordance with claim 5, wherein a sheath structure is utilized to absorb heat from the fuel cell stacks using coolant in said sheath structure for cooling at least one of an anode side and a cathode side of the fuel cell system.

9. A high temperature fuel cell system comprising:
a cooling arrangement that reduces an amount of purge gas in a system emergency shutdown situation, wherein each fuel cell in the fuel cell system having an anode side, a cathode side, and an electrolyte between the anode side and the cathode side, the fuel cells being arranged in fuel cell stacks;
the cooling arrangement including:
a coolant source that provides coolant to be used in a cooling process of the high temperature fuel cell system during the system shutdown situation,
a cooling structure connected to the coolant source and arranged in a thermal effect area of the fuel cell stacks to receive heat from the fuel cell stacks at least by radiation, and transferring received heat to the coolant;
a membrane expression vessel that feeds said coolant into the cooling structure from the coolant source;
a heat exchanger that exhausts used coolant from the cooling structure;
an actuated device that utilizes a triggering force to trigger a coolant flow in the cooling structure, when the system shutdown situation has started;
wherein the membrane expression vessel includes feeding a separate tank arrangement configured to use pressurized gas as a driving force to feed the coolant into the cooling structure, and the actuated device dimensioning the flow rate of coolant according to a cooling duty and allowed cooling rate of the fuel cell stacks using a triggering force to perform passive self-actuation type operation.

10. The high temperature fuel cell system in accordance with claim 9, wherein the cooling arrangement includes water as said coolant to receive heat from the fuel cell system, and using a phase transition of water to steam in the cooling process.

11. The high temperature fuel cell system in accordance with claim 9, wherein the cooling structure includes platy structure parts for the coolant to enhance heat radiation absorption efficiency of the cooling structure.

12. The high temperature fuel cell system in accordance with claim 9, wherein the cooling structure includes a sheath structure to absorb heat from the fuel cell stacks by using said coolant to cool at least one of the anode side and cathode side of the fuel cell system.
